(19) United States
(12) Patent Application Publication
(10) Pub. No.: US 2009/0274080 A1
(43) Pub. Date: Nov. 5, 2009

(54) Method for Unifying Operations of Boards by Using Logical Addresses Thereof

(75) Inventor: Yoon Mi Hwang, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTSTARCOM, INC., Alameda, CA (US)

(21) Appl. No.: 11/534,960

(22) Filed: Sep. 25, 2006

Related U.S. Application Data
(63) Continuation of application No. 10/559,235, now abandoned.

(30) Foreign Application Priority Data
Jul. 24, 2003 (KR) 10-2003-0051155

(51) Int. Cl. H04B 7/00

(52) U.S. Cl. 370/310.1

(57) ABSTRACT

The present invention relates to a method or unifying operations of a plurality of boards in a CDMA communication system by using logical addresses of the boards. Conventionally, since a board with a physical slot ID must be attached to a slot of the system corresponding to the physical slot ID, the board cannot be recognized by the system if it is attached to another slot of the system. In the present invention, a board is attached to a slot of the system on the basis of a logical address of the board, which is stored in a board configuration information. According to the present invention, since a board can be attached to any slot of the system regardless of the physical slot ID of the board, the boards can be easily managed.

### TECHNICAL FIELD

The present invention relates to a method of unifying operations of a plurality of boards in a CDMA communication system through using logical addresses of the boards.

### BACKGROUND ART

Conventionally, the CDMA communication system classifies the boards that are mounted on a rack according to a physical slot ID and loads applications by using the physical slot ID.

### DISCLOSURE OF INVENTION

### Technical Problem

Since a board with the physical slot ID must be attached to a slot of the system which corresponds to the physical slot ID, the board cannot be recognized by the system if it is attached to another slot of the system. In this respect, it is not possible to unify the operations of a plurality of boards that are different from each other in terms of form.

### Technical Solution

It is, therefore, an objective of the present invention to provide a method of unifying operations of a plurality of boards in a CDMA communication system through using logical addresses of the boards. A board is attached to a slot of the system on the basis of a logical address of the board, which is stored in board configuration information.

The first embodiment of the present invention for achieving the above objective is a method for unifying operations of a plurality of boards in a CDMA communication system comprising the following features: a Base Station Manager (BSM) having a BSM System Loader Application (MSLA); a Call Control Processor (CCP) having a CCP Operating System Block (CCOS); a Common Block Loader Application (XBLA) and a CCP Loader Application (CCLA); an Enhanced Vocoder eXecution Assembly (EVXA) having a CCP EVXA Operating System Block (CSOS) and a Common Block Loader Application (XBLA). The CCP is configured to execute the steps of: requesting board configuration information to the BSM; upon receipt of the board configuration information, setting an ATM address table by using the board configuration information; requesting loading to the BSM by using the ATM address table; upon receipt of the loading from the BSM, executing a main loader; requesting loading of CCP applications to the BSM from the main loader; upon receipt of a board configuration information request from the CSOS, transmitting to the CSOS the board configuration information received from the BSM; upon receipt of a BSC ID request from the CSOS, transmitting the BSC ID to the CSOS; and upon receipt of request for loading of applications from the EVXA, loading applications according to the request.

The second embodiment of the present invention for achieving the above objective is a method for unifying operations of a plurality of boards in a CDMA communication system comprising the following features: a Base Station Manager (BSM) having a BSM System Loader Application (MSLA); a Call Control Processor (CCP) having a CCP Operating System Block (CCOS); a Common Block Loader Application (XBLA) and a CCP Loader Application (CCLA); an Enhanced Vocoder execution Assembly (EVXA) having a CCP EVXA Operating System Block (CSOS) and a Common Block Loader Application (XBLA). The BSM is configured to execute the steps of: upon receipt of request for board configuration information from the CCOS, reading PLD and transmitting the board configuration information that is suitable in form to the CCOS; upon receipt of request for loading of applications from the XBLA in the CCP, loading applications according to the request; and upon receipt of request for loading of CCP applications from the CCLA in the CCP, loading CCP applications according the request.

The third embodiment of the present invention for achieving the above objective is a method for unifying operations of a plurality of boards in a CDMA communication system comprising the following features: a Base Station Manager (BSM) having a BSM System Loader Application (MSLA); a Call Control Processor (CCP) having a CCP Operating System Block (CCOS); a Common Block Loader Application (XBLA) and a CCP Loader Application (CCLA); an Enhanced Vocoder execution Assembly (EVXA) having a CCP EVXA Operating System Block (CSOS) and a Common Block Loader Application (XBLA). The EVXA is configured to execute the steps of: requesting board configuration information to the CCOS; upon receipt of the board configuration information, requesting a BSC ID to the CCLA; upon receipt of the BSC ID, setting an ATM address table based on the BSC ID and the board configuration information and running the XBLA; and requesting loading of EVXA applications to the CCLA from the XBLA.

### ADVANTAGEOUS EFFECTS

According to the present invention, since a board can be attached to any slot of the system regardless of the physical slot ID of the board, the boards can be easily managed.

The foregoing and other objects and features of the present invention will become more fully apparent from the following description, appended claims and their accompanying drawings.

### BRIEF DESCRIPTION OF THE DRAWINGS

Understanding that these drawings depict only typical embodiments of the invention and are, therefore, not to be considered limiting of its scope, the invention will be described with additional specificity and detail through use of the accompanying drawings in which:

FIG. 1 is a perspective view of a preferred embodiment of the present invention, illustrating the flow of unifying operations of a plurality of boards in a CDMA system by using logical addresses of the boards.

FIG. 2 is a flowchart of a preferred embodiment of the present invention, illustrating the loading process of applications from the CCP to the BSM by using logical addresses of the boards.

FIG. 3 is a flowchart of a preferred embodiment of the present invention, illustrating the loading process of applications from the CCP to the EVXA by using logical addresses of the boards.

FIG. 4 is a flowchart of a preferred embodiment of the present invention, illustrating the loading process of applications from the BSM to the CCP by using logical addresses of the boards.

FIG. 5 is a flowchart of a preferred embodiment of the present invention, illustrating the loading process of applications from the EVXA to the CCP by using logical addresses of the boards.

FIGS. 6 and 7 are tables of a preferred embodiment of the present invention, illustrating the conversion between the physical IP and the logical ID.

### BEST MODE FOR CARRYING OUT THE INVENTION

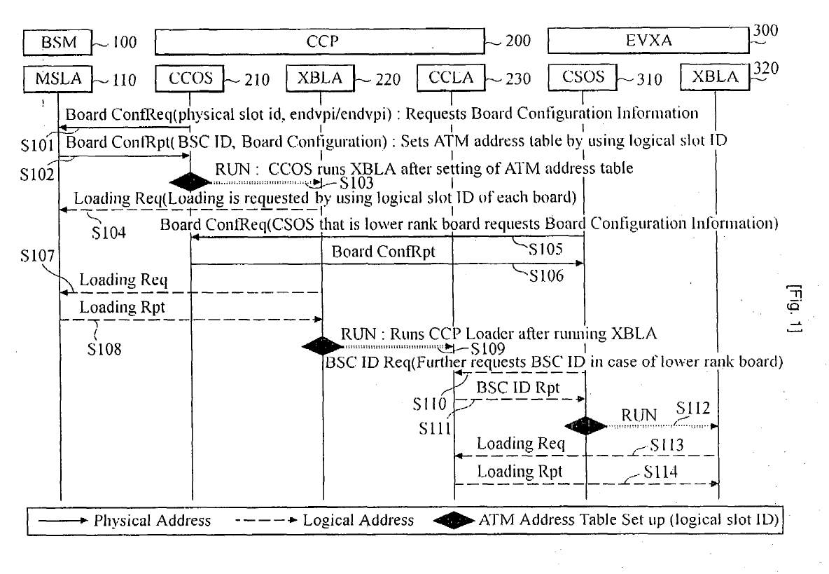

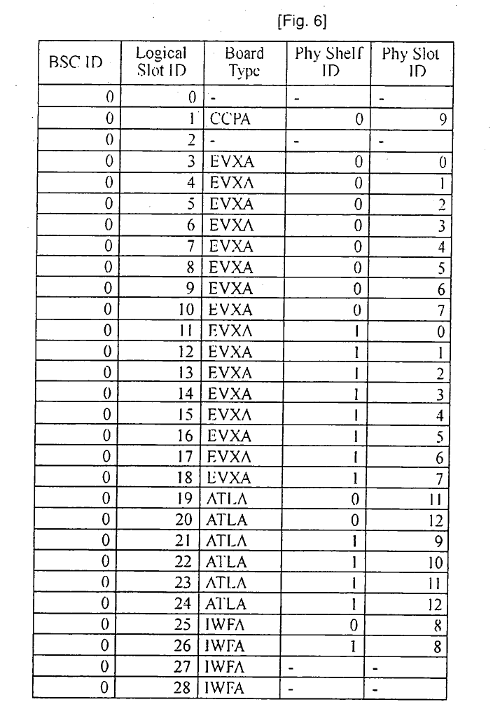

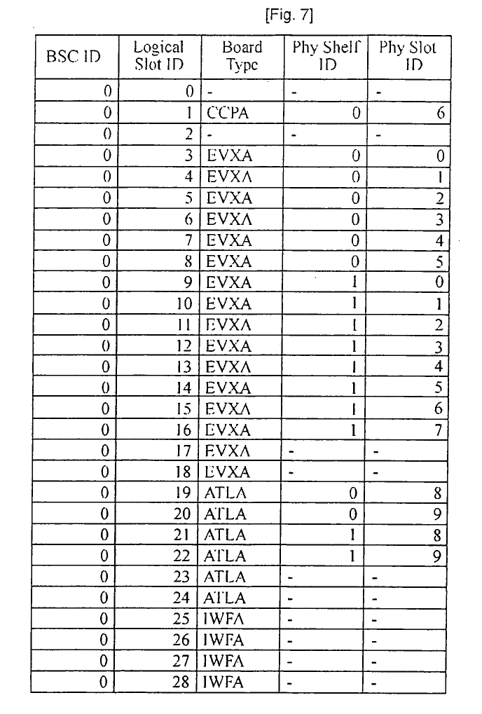

It will be readily understood that the components and steps of the present invention, as generally described and illustrated in the Figures herein and accompanying text, could be arranged and designed in a wide variety of different configurations while still utilizing the inventive concept. Thus, the following detailed description of the preferred embodiments of the method of the present invention, as represented in FIGS. 1 through 6 and accompanying text, is not intended to limit the scope of the invention, as claimed, but it is merely representative of the presently preferred embodiments of the invention. The presently preferred embodiments of the invention will be best understood by reference to the drawings, wherein like parts or steps are designated by like numerals throughout.

The present invention unifies operations of a plurality of boards in a CDMA communication system by using logical addresses of the boards, even if the boards are different from each other in form as in the case of an IBS package (CDMA-2000 1x InBuilding system) and 3G-1XWILL system.

The logical slot ID that corresponds to the physical slot ID is predefined and fabricated into a PLD (p-bsm) in order to unify the operations of two systems which are different from each other in terms of form.

The fabricated PLD comprises a board configuration information of a physical slot ID, a physical Shelf ID, a board type, a logical slot ID, etc., and manages the BSM. When the CCP requests the board configuration information while being initialized, the MSLA that is a BSM loader reads the PLD. It then extracts the necessary board configuration information and downloads the information to the CCP.

The operations of the above will be described in further detail as follows.

FIG. 1 illustrates the flow of unifying operations of a plurality of boards in a CDMA system by using logical addresses of the boards.

Where, reference numeral 100 denotes a Base Station Manager (BSM) having a BSM System Loader Application (MSLA); reference numeral 200 denotes a Call Control Processor (CCP) having a CCP Operating System Block (CCOS) 210, a Common Block Loader Application (XBLA) 220 and a CCP Loader Application (CCLA) 230; and reference numeral 300 denotes an Enhanced Vocoder eXecution Assembly (EVXA) having a CCP EVXA Operating System Block (CSOS) 310 and a Common Block Loader Application (XBLA) 320.

A method for unifying operations of a plurality of boards in a CDMA communication system will be described in detail as follows.

First, in step S102, CCOS 210 requests board configuration information (for example, a physical slot IP, endvpi, etc) to MSLA 110. In step S102, MSLA 110 searches the PLD, extracts the board configuration information, and transmits the information to CCOS 210.

Then, in step S103, CCOS 210 sets an ATM address table by using a logical ID among the received board configuration information and runs XBLA 220 after setting of the ATM address table.

In step S104, XBLA 220 requests loading to MSLA 110 by using the logical ID of each board.

In step S105, CSOS 310 requests the board configuration information to CCOS 210; and in step S106, CCOS 210 transmits the board configuration information to CSOS 310.

In step S107, XBLA 220 requests loading to MSLA 110; in step S108, MSLA 110 loads the request information to XBLA 220: and in step S109, XBLA 220 executes CCLA 230.

In step S110, CSOS 310 requests BSC ID to CCLA 230; in step S111, CCLA 230 transmits BSC ID to CSOS 310; and in step S112, CSOS 310 executes XBLA 320.

Then, in step S113, XBLA 320 requests loading to CCLA 230; and in step S114, CCLA 230 loads the requested information to XBLA 320.

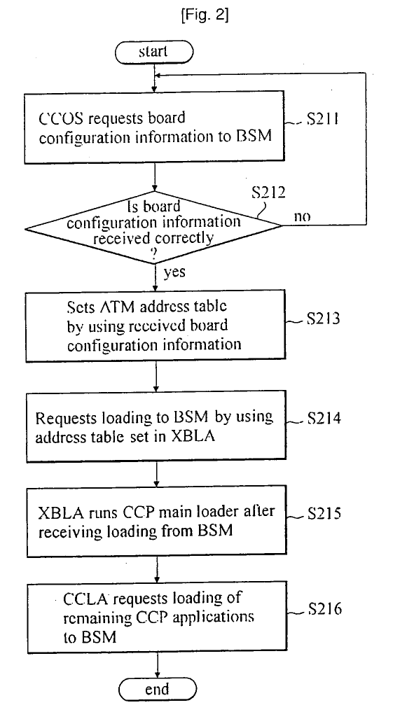

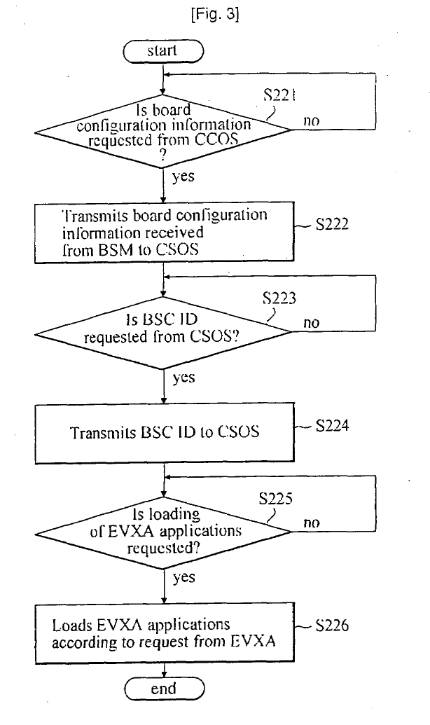

FIG. 2 illustrates the loading process of applications from the CCP to the BSM by using logical addresses of the boards; and FIG. 3 illustrates the loading process of applications from the CCP to the EVXA by using logical addresses of the boards.

As described in FIGS. 2 and 3, the flow comprises step S211 to step S213 that requests board configuration information to BSM 100, determines whether the received board configuration information is exact or not, and sets an ATM address table by using the received board configuration information; step S214 that requests loading to BSM 100 by using the address table; step S215 that executes a main loader upon receipt of loading from BSM 100; step S216 that requests loading of CCP applications to BSM 100 from the main loader; step S221 to step S222 that determines whether the board configuration information is requested from BSM 100 and transmits the board configuration information transmitted from BSM 100 to CSOS 310; step S223 to step S224 that determines whether a BSC ID is requested from CSOS 310 and transmits the BSC ID to CSOS 310; and step S225 to step S226 that determines whether loading of EVXA applications is requested and loads EVXA applications according to the request from EVXA 300.

The steps of FIGS. 2 and 3 will be described in further detail as follows.

CCP 200 requests board configuration information to BSM 100 in step S211, and determines whether the received board configuration information is exact or not in step S212. It then sets an ATM address table by using the received board configuration information when the board configuration information is received correctly in step S213.

Then, XBLA 220 requests loading to BSM 100 by using the address table in step S214 and executes a CCP main loader upon receipt of loading from BSM 100 in step S215.

Then, CCLA 230, which is the main loader, requests loading of CCP applications to BSM 100 in step S216.

Subsequently, when the board configuration information is requested from BSM 100 in step S221, the board configuration information received from BSM 100 is transmitted to CSOS 310 in step S222.

A BSC ID is then requested from CSOS 310 in step S223; the BSC ID is transmitted to CSOS 310 in step S224, and when loading of applications from EVXA is requested in step S225, EVXA applications are loaded according to the request from EVXA 300 in step S226.

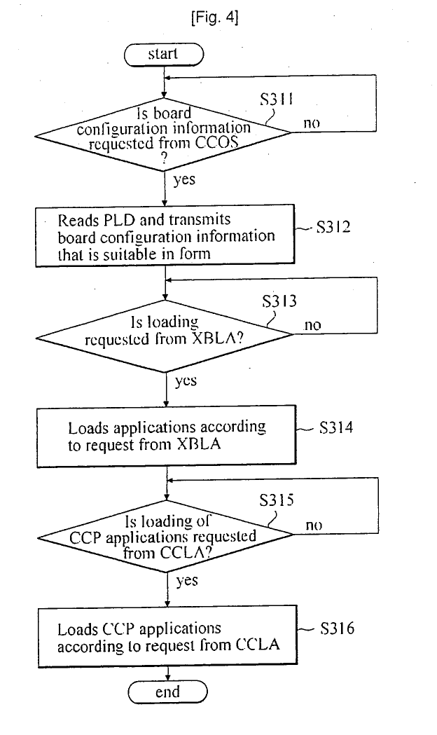

FIG. 4 illustrates the loading process of applications from the BSM to the CCP by using logical addresses of the boards.

As described in FIG. 4, the flow comprises step S311 to step S312 that determines whether the board configuration information is requested from CCOS 210 and reads the PLD and transmits the board configuration information that is suitable in form to CCOS 210; step S313 to step S314 that determines whether loading of applications is requested from XBLA 220 in CCP 200 and loads applications according to the request; and step S315 and step S316 that determines whether loading of CCP applications is requested from CCLA 230 in CCP 200 and loads CCP applications according to the request from CCLA 230.

The steps of FIG. 4 will be described in further detail as follows.

CCOS 210 requests board configuration information in step S311; and BSM 100 reads the PLD and transmits the board configuration information that is suitable in form to CCOS 210 in step S312.

When loading of applications is requested from XBLA 220 in CCP 200 in step S313, the applications are loaded according to the request in step S314.

Then, when loading of CCP applications is requested from CCLA 230 in CCP 200 in step S315, CCP applications are loaded according to the request from CCLA 230 in step S316.

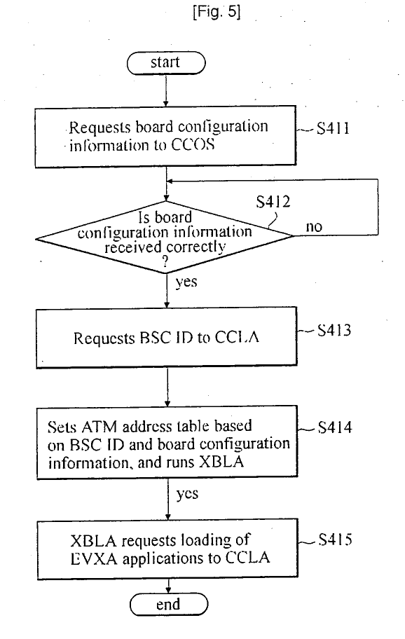

FIG. 5 illustrates the loading process of applications from the EVXA to the CCP by using logical addresses of the boards.

As described in FIG. 5, the flow comprises step S411 to step S413 that the board configuration information is requested to CCOS 210, determines whether the requested information is received correctly, and the BSC ID is requested to CCLA 230; step 5414 that sets an ATM address table based on the BSC ID and the board configuration information when the requested BSC ID is received and runs XBLA 320; and step 5415 that loading of EVXA applications is requested to CCLA 230 from XBLA 320.

The steps of FIG. 5 will be described in further detail as follows.

EVXA 300 requests the board configuration information to CCOS 210 in step S411. When the requested board configuration information is received correctly in step S412, the BSC ID is requested to CCLA 230 in step S413.

Then, the ATM address table is set based on the BSC ID and the board configuration information when the requested BSC ID is received and XBLA 320 is run in step S414.

Thereafter, XBLA 320 requests loading of the EVXA applications to CCLA in step S415.

### INDUSTRIAL APPLICABILITY

In accordance with the present invention, there is provided a method for unifying operations of a plurality of boards in a CDMA communication system by using logical addresses of the boards. The board is attached to a slot of the system on the basis of a logical address of the board, which is stored in board configuration information.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. A method for unifying operations of a plurality of boards in a CDMA communication system comprising a Base Station Manager (BSM) having a BSM System Loader Application (MSLA), a Call Control Processor (CCP) having a CCP Operating System Block (CCOS), a Common Block Loader Application (XBLA) and a CCP Loader Application (CCLA), and an Enhanced Vocoder eXecution Assembly (EVXA) having a CCP EVXA Operating System Block (CSOS) and a Common Block Loader Application (XBLA), wherein the CCP is configured to execute the steps of:
requesting board configuration information to the BSM;
upon receipt of the board configuration information, setting an ATM address table by using the board configuration information;
requesting loading to the BSM by using the ATM address table;
upon receipt of the loading from the BSM, executing a main loader;
requesting loading of CCP applications to the BSM from the main loader;
upon receipt of a board configuration information request from the CSOS, transmitting to the CSOS the board configuration information received from the BSM;
upon receipt of a BSC ID request from the CSOS, transmitting the BSC ID to the CSOS; and
upon receipt of request for loading of applications from the EVXA, loading applications according to the request.

2. A method for unifying operations of a plurality of boards in a CDMA communication system comprising a Base Station Manager (BSM) having a BSM System Loader Application (MSLA), a Call Control Processor (CCP) having a CCP Operating System Block (CCOS), a Common Block Loader Application (XBLA) and a CCP Loader Application (CCLA), and an Enhanced Vocoder eXecution Assembly (EVXA) having a CCP EVXA Operating System Block (CSOS) and a Common Block Loader Application (XBLA), wherein the BSM is configured to execute the steps of:
upon receipt of request for board configuration information from the CCOS, reading PLD and transmitting the board configuration information that is suitable in form to the CCOS;
upon receipt of request for loading of applications from the XBLA in the CCP, loading applications according to the request; and
upon receipt of request for loading of CCP applications from the CCLA in the CCP, loading CCP applications according to the request.

3. A method for unifying operations of a plurality of boards in a CDMA communication system comprising a Base Station Manager (BSM) having a BSM System Loader Application (MSLA), a Call Control Processor (CCP) having a CCP Operating System Block (CCOS), a Common Block Loader Application (XBLA) and a CCP Loader Application (CCLA), and an Enhanced Vocoder eXecution Assembly (EVXA) having a CCP EVXA Operating System Block (CSOS) and a Common Block Loader Application (XBLA), wherein the EVXA is configured to execute the steps of:
requesting board configuration information to the CCOS:
upon receipt of the board configuration information, requesting a BSC ID to the CCLA;
upon receipt of the BSC ID, setting an ATM address table based on the BSC ID and the board configuration information and running the XBLA; and
requesting loading of EVXA applications to the CCLA from the XBLA.
